(19) United States
(12) Patent Application Publication
(10) Pub. No.: US 2026/0184952 A1
(43) Pub. Date: Jul. 2, 2026

(54) PROJECTION WRITING AND ERASING FILM AND PREPARATION METHOD AND USE THEREOF

(71) Applicant: Guangzhou Newlife New Material Co., LTD., Guangzhou (CN)

(72) Inventors: Ronggen YE, Guangzhou (CN); Guoming WU, Guangzhou (CN); Zhiqiang CHEN, Guangzhou (CN); Xiaoming WANG, Guangzhou (CN)

(21) Appl. No.: 18/730,473

(22) PCT Filed: Jul. 3, 2024
(86) PCT No.: PCT/CN2024/103333

§ 371 Date: Jul. 19, 2024

(30) Foreign Application Priority Data
Jul. 12, 2023 (CN) 202310857446.5

(51) Int. Cl. C09D 135/02; C08J 5/12; C08J 7/04; C09D 4/06; C09D 5/14

(52) U.S. Cl. CPC C09D 135/02; C08J 5/128; C08J 7/0427; C09D 4/06; C09D 5/14; C08J 2367/02; C08J 2435/02; C08J 2475/04

(57) ABSTRACT

The present disclosure relates to a projection writing and erasing film and a preparation method and use thereof. The projection writing and erasing film includes a surface structured layer, a film base material layer and an installation layer which are arranged in a stacked mode, where the surface structured layer is a matte coating with a roughened surface structure, and the installation layer is a ferromagnetic layer or an adhesive layer. The projection writing and erasing film provided by the present disclosure can not only satisfy the projection effect, take into account writing and erasing functions, but also has multiple functions such as a magnetic adsorption function, and an antibacterial function.

### CROSS-REFERENCE TO RELATED APPLICATION

This application is the United States national phase of International Patent Application No. PCT/CN2024/103333, filed Jul. 3, 2024, and claims priority to Chinese Patent Application No. 202310857446.5, filed Jul. 12, 2023, the disclosures of which are hereby incorporated by reference in their entireties.

### TECHNICAL FIELD

The present disclosure relates to the technical field of projection materials, and in particular, to a projection writing and erasing film and a preparation method and use thereof.

### BACKGROUND

Generally, whiteboard writing and erasing products require a smooth surface, on which you can easily write with a water-based pen in clear handwriting, and the handwriting can be easily wiped off. Such writing and wiping functions bring a lot of convenience and are widely used in offices, stationery, and education. Most whiteboards are high-gloss products, with a gloss of above 90°, a small surface roughness, and good writing and writing and erasing effects.

In an office meeting projection, if a high brightness of the projector cannot be evenly dispersed in a projection area, the following two situations are likely to occur: firstly, strong reflection causes unclear visibility, that is, glare, and secondly, it easily causes eye fatigue for viewers, making it unsuitable for projection. In order to solve the glare problem, technical workers often add matting powder to make the surface uneven and achieve a certain matting effect. A powder particle size of the matting powder is generally controlled within 3 μm to 5 μm for better matting effect. The matting powder is mainly represented by silica having a density of 2.22 g/cm³ to 2.65 g/cm³, which is higher than that of the resin and solvent. If a matte UV coating has a low viscosity, dispersion and sedimentation may easily occur, causing uniformity of the coating, resulting in unstable gloss of a product; if the viscosity is relatively high, sedimentation does not easily occur in the powder, however, dispersion and leveling are more difficult and the apparent quality is not ideal. For this reason, the current matte whiteboard products have the gloss around 40°, the writing and erasing effect is significantly reduced, and there are still light spots and partial reflections during projection, which will also cause eye fatigue for viewers. In addition, if the handwriting is left on the board for more than 3 days, ink will penetrate into the matting powder or between troughs, so that there is no chance for an eraser to come into contact the handwriting, resulting in wipe residue.

In order to solve the problems of gloss stability and ink penetration, the prior art has disclosed a whiteboard and a reflective projection screen, and proposed that the surface is structured by an embossing process, to achieve a certain matting effect. The process is to apply coating on the surface of the film, where the coating is first cured by UV, and then heated and embossed from the coating surface or the base surface. The surface has an arithmetic average roughness number Ra of 1.0 μm to 4.0 μm, and a surface contour of an embossing roller has an average width RSm of 30 μm to 300 μm. The embossing, writing and erasing and projection effects from the front side of the coating and the base surface are compared. The base surface has the most ideal embossing effect, but has no ideal embossing effect beyond a corresponding range, and parameters such as gloss, projection gain effect, and viewing angle are not explained. However, the production of embossing rollers is difficult and costly, and the product width is limited.

The prior art further discloses a combined dry erase board/projection screen, which uses fluorinated oligomers or fluorinated monomers to improve erasability, however, such substances are generally expensive. The process is to first apply UV coating, curing the coating with UV light, followed by heat (50° C. to 270° C.) embossing treatment at a pressure of 0.4 MPa to 1.0 MPa. A product surface has an arithmetic average roughness Ra of 1 μm to 5 μm, an average ridge spacing RSm between adjacent ridges of 200 μm to 800 μm, the maximum roughness depth Rt of 1 μm to 30 μm, and a gloss of below 30 degrees. A pressure-sensitive adhesive is applied to the surface of the base material for bonding with other materials.

The embossed surface can achieve a limited fineness, a roughness Ra of 1.0 μm to 4.0 μm, and an average distance between adjacent bumps on the surface of 30 μm to 300 μm, indicating that there are many flat and high-gloss areas, and there are still some light spots as the brightness of the projector increases. If the roughness Ra is less than 1.0 μm, there will be a problem of writing and erasing residue. In addition, there are some shortcomings in the heating embossing process. Firstly, the film base material is unstable during post-processing and production, such as high-temperature coating and processing of hot melt adhesive. Secondly, it is glue-free lamination of other products online, and a certain temperature and pressures will cause patterns to disappear.

### SUMMARY

The present disclosure aims to at least solve the technical problem of being unable to achieve both projection and writing and erasing in the prior art. To this end, an object of the present disclosure is to provide a projection writing and erasing film that can not only satisfy the projection effect, take into account writing and erasing functions, but also have multiple functions such as a magnetic adsorption function and an antibacterial function. The second object of the present disclosure is to provide a method for preparing such a projection writing and erasing film. The third object of the present disclosure is to provide a use of such a projection writing and erasing film.

In order to achieve the above objects, the technical solutions used by the present disclosure are as follows:
A first aspect of the present disclosure provides a projection writing and erasing film, including a surface structured layer, a film base material layer and an installation layer which are arranged in a stacked mode;
where the surface structured layer is a matte coating with a roughened surface structure; and
the installation layer is a ferromagnetic layer or an adhesive layer.

According to some embodiments of the projection writing and erasing film of the present disclosure, the surface structured layer has at least one of the following characteristics (a) to (d):
(a) a surface gloss≤30°;
(b) Ra of 0.10 μm to 1.0 μm;
(c) Rt of 1.0 μm to 5.0 μm; and
(d) a thickness of 1 μm to 20 μm.
wherein, Ra represents an arithmetic average roughness; and Rt represents a maximum peak-trough vertical distance.

According to some embodiments of the projection writing and erasing film of the present disclosure, the surface gloss of the surface structured layer is ≤25°.

According to some embodiments of the projection writing and erasing film of the present disclosure, the Ra of the surface structured layer is 0.15 μm to 1 μm.

According to some embodiments of the projection writing and erasing film of the present disclosure, the Ra of the surface structured layer is 0.2 μm to 0.8 μm.

According to some embodiments of the projection writing and erasing film of the present disclosure, the Rt of the surface structured layer is 1.5 μm to 4.5 μm.

According to some embodiments of the projection writing and erasing film of the present disclosure, the Rt of the surface structured layer is 2.0 μm to 4.0 μm.

According to some embodiments of the projection writing and erasing film of the present disclosure, a Rz (ten-point height of microscopic roughness) of the surface structured layer is 1 μm to 5 μm.

According to some embodiments of the projection writing and erasing film of the present disclosure, the Rz of the surface structured layer is 1.2 μm to 4 μm.

According to some embodiments of the projection writing and erasing film of the present disclosure, a Rq (contour root mean square deviation) of the surface structured layer is 0.1μ m to 1μ m.

According to some embodiments of the projection writing and erasing film of the present disclosure, the Rq of the surface structured layer is 0.2 μm to 0.8 μm.

According to some embodiments of the projection writing and erasing film of the present disclosure, a film thickness of the surface structured layer is 1 μm to 10 μm.

According to some embodiments of the projection writing and erasing film of the present disclosures, the surface structured layer is formed by compounding a projection writing and erasing curable coating and a soft film with a roughened surface structure, curing and shaping, and then separating the projection writing and erasing curable coating from the soft film.

According to the projection writing and erasing curable coating of the present disclosure, the term “curable” means that the coating can be cured by ultraviolet (UV) or electron beam (EB).

According to some embodiments of the projection writing and erasing film of the present disclosure, the projection writing and erasing curable coating includes the following preparation components: a base material, a photoinitiator, an antibacterial agent, and a writing and erasing aid. The base material includes acrylate resin prepolymers and acrylate-type monomers; and the writing and erasing aid is a fluorosilicone co-modified polyacrylate resin.

According to some embodiments of the projection writing and erasing film of the present disclosure, the projection writing and erasing curable coating includes the following preparation components in parts by mass: 25 to 55 parts of acrylate resin prepolymers, 12 to 48 parts of acrylate-type monomers, 1.0 to 4.0 parts of photoinitiator, 1 to 8 parts of antibacterial agent, and 1 to 5 parts of the writing and erasing aid; and the writing and erasing aid includes the following preparation components in parts by mass: 8 to 12 parts of hydrogen silicone oil, 3 to 8 parts of silane monomers, 20 to 55 parts of bifunctional (meth)acrylate monomers, 1 to 3 parts of fluorine-containing (meth)acrylate monomers, 7×10⁻⁴ to 1.5×10⁻³ parts of catalyst, and 0.3 to 0.6 parts of polymerization inhibitor.

The bifunctional (meth)acrylate monomers mean bifunctional acrylate monomers and/or bifunctional methacrylate monomers; and the fluorine-containing (meth)acrylate monomers mean fluorine-containing acrylate monomers and/or fluorine-containing methacrylate monomers.

According to some embodiments of the projection writing and erasing curable coating of the present disclosure, the acrylate resin prepolymer includes at least one of epoxy acrylate, polyurethane acrylate, polyester acrylate, or hyperbranched acrylate.

According to some embodiments of the projection writing and erasing curable coating of the present disclosure, the acrylate resin prepolymer includes at least one of polyurethane acrylate with a functionality of ≥3, epoxy acrylate with a functionality of ≥2, or hyperbranched acrylate with a functionality of ≥6.

According to some embodiments of the projection writing and erasing curable coating of the present disclosure, the acrylate resin prepolymer includes at least one of Eternal 6145-100, 6195-100, 621A-80, 6363, 6158B-80, DR-U195, SARTOMER CN989, Bayer U400, or B175X.

According to some embodiments of the projection writing and erasing curable coating of the present disclosure, the acrylate-type monomers include acrylate-type monomers with a functionality of ≥2.

According to some embodiments of the projection writing and erasing curable coating of the present disclosure, the acrylate-type monomers include at least one of trimethylolpropane triacrylate (TMPTA), 1,6-hexanediol diacrylate (HDDA), Ethoxylated trimethylolpropane triacrylate (EO3TMPTA), dipentaerythritol hexaacrylate (DPHA), pentaerythritol triacrylate (PETA), propoxyneopentyl glycol diacrylate (PONPGDA), or polyethylene glycol (200) diacrylate (PEG (200) DA).

According to some embodiments of the projection writing and erasing curable coating of the present disclosure, the photoinitiator includes at least one of a benzoin-type initiator, a benzoyl-type initiator, an alkylphenone-type initiator, an acyl phosphorus oxide initiator, a benzophenone-type initiator or a thioxanthone-type initiator.

According to some embodiments of the projection writing and erasing curable coating of the present disclosure, the photoinitiator includes at least one of 1-hydroxycyclohexyl phenyl ketone (photoinitiator 184), 2-hydroxy-2-methyl-1-phenyl-1-propanone (photoinitiator 1173) or 2,4,6-trimethylbenzoyl-diphenylphosphine oxide (photoinitiator TPO).

According to some embodiments of the projection writing and erasing curable coating of the present disclosure, the antibacterial agent includes at least one of organic silicon quaternary ammonium salt-type antibacterial agents, nano-inorganic particle-loaded silver ion antibacterial agents, or nano-inorganic particle-loaded zinc ion antibacterial agents.

According to some embodiments of the writing and erasing aid of the present disclosure, the hydrogened silicone oil has a hydrogen content of 1.05 wt % to 1.4 wt %.

According to some embodiments of the writing and erasing aid of the present disclosure, the silane monomer includes at least one of vinyltrimethoxysilane, vinyltriethoxysilane, γ-methacryloyloxy propyl trimethoxysilane or γ-methacryloyloxy propyl triethoxysilane.

According to some embodiments of the writing and erasing aid of the present disclosure, the bifunctional (meth)acrylate monomers include at least one of ethylene glycol di(meth)acrylate, 1,6-hexanediol di(meth)acrylate, polyethylene glycol di(meth)acrylate, dipropylene glycol di(meth)acrylate, tripropylene glycol di(meth)acrylate, triethylene glycol di(meth)acrylate, di(meth)acrylate, or 1,4-butanediol neopentyl glycol di(meth)acrylate, 1,3-butanediol di(meth)acrylate.

According to some embodiments of the writing and erasing aid of the present disclosure, the bifunctional (meth)acrylate monomers include at least one of 1,6-hexanediol diacrylate, tripropylene glycol diacrylate, or neopentyl glycol diacrylate.

According to some embodiments of the writing and erasing aid of the present disclosure, the fluorine-containing (meth)acrylate monomer includes at least one of trifluoroethyl (meth)acrylate, hexafluorobutyl (meth)acrylate, dodecafluoroheptyl or (meth)acrylate tridecafluorooctyl (meth)acrylate.

According to some embodiments of the writing and erasing aid of the present disclosure, the fluorine-containing (meth)acrylate monomer includes at least one of trifluoroethyl methacrylate, hexafluorobutyl methacrylate, dodecafluoroheptyl acrylate or tridecafluorooctyl acrylate.

According to some embodiments of the writing and erasing aid of the present disclosure, the catalyst is a platinum-based catalyst.

According to some embodiments of the writing and erasing aid of the present disclosure, the catalyst is chloroplatinic acid.

According to some embodiments of the writing and erasing aid of the present disclosure, the catalyst participates in the preparation method in the form of a catalyst solution. In some embodiments of the disclosure, the catalyst solution is a chloroplatinic acid isopropanol solution.

According to some embodiments of the writing and erasing aid of the present disclosure, the polymerization inhibitor includes at least one of p-hydroxyanisole, hydroquinone, p-benzoquinone, methylhydroquinone, phenothiazine, 2,5-di-tert-butylhydroquinone or 2-tert-butylhydroquinone. The polymerization inhibitors are conventional raw materials in the art and can be selected and used according to actual needs.

According to some embodiments of the writing and erasing aid of the present disclosure, in the preparation components of the writing and erasing aid, a molar ratio of carbon-carbon double bonds (C═C bonds) to silicon-hydrogen bonds (Si—H bonds) is (2.1-2.4): 1.

According to some embodiments of the writing and erasing aid of the present disclosure, the preparation method of the writing and erasing aid includes the following steps:
step 1): mixing the hydrogened silicone oil, silane monomer, fluorine-containing (meth)acrylate monomer and polymerization inhibitor to obtain a mixture, heating the mixture, and adding part of the catalyst thereinto for reaction; and
step 2): further adding the remaining catalyst and bifunctional (meth)acrylate monomers to react to obtain the writing and erasing aid.

According to some embodiments of the preparation method of the writing and erasing aid of the present disclosure, the preparation process is carried out under a protective gas. In some embodiments of the present disclosure, the protective gas is nitrogen.

According to some embodiments of the preparation method of the writing and erasing aid of the present disclosure, in step 1), a heating temperature is 80° C. to 110° C.

According to some embodiments of the preparation method of the writing and erasing aid of the present disclosure, in step 1), part of the catalyst refers to adding a catalyst accounting for 20% to 72% of the total catalyst ratio.

According to some embodiments of the preparation method of the writing and erasing aid of the present disclosure, in step 1), part of the catalyst refers to adding a catalyst accounting for 30% to 50% of the total catalyst ratio.

According to some embodiments of the preparation method of the writing and erasing aid of the present disclosure, in step 1), a catalyst solution is added during the heating process. In some embodiments of the present disclosure, the catalyst solution is added for a period of time of 1 hour to 3 hours. The catalyst solution is chloroplatinic acid isopropanol solution; and the method of addition is dropwise addition.

According to some embodiments of the preparation method of the writing and erasing aid of the present disclosure, in step 1), the reaction is carried out at 80° C. to 110° C. for a period of time of 3 hours to 7 hours.

According to some embodiments of the preparation method of the writing and erasing aid of the present disclosure, in step 2), the temperature of the reaction system is adjusted to 80° C. to 90° C., and then the remaining catalyst and bifunctional (meth)acrylate monomers are further added.

According to some embodiments of the preparation method of the writing and erasing aid of the present disclosure, in step 1), 3×10⁻⁴ to 5×10⁻⁴ parts by mass of catalyst are first added, and then in step 2), 4×10⁻⁴ to 1×10⁻³ parts by mass of catalyst are further added.

According to some embodiments of the preparation method of the writing and erasing aid of the present disclosure, in step 2), the period of time for further adding the remaining catalyst and the bifunctional (meth)acrylate monomers is 0.5 hours to 1.5 hours. In some embodiments of the present disclosure, the remaining catalyst and the difunctional (meth)acrylate monomers are added by dropwise addition.

According to some embodiments of the preparation method of the writing and erasing aid of the present disclosure, in step 2), samples are taken for infrared testing during the reaction process. When a absorption peak at 2,167 cm⁻¹ (Si—H bond stretching vibration) in the infrared spectrum of the product disappears, it is the end point of the reaction.

According to some embodiments of the projection writing and erasing curable coating of the present disclosure, the components of the projection writing and erasing curable coating further include at least one of a leveling agent or a diluent.

According to some embodiments of the projection writing and erasing curable coating of the present disclosure, when the components of the projection writing and erasing curable coating further include a leveling agent, the mass part of the leveling agent is 0.1 to 0.5 parts.

According to some embodiments of the projection writing and erasing curable coating of the present disclosure, the leveling agent includes at least one of an acrylate-type leveling agent, an organosilicon-type leveling agent, or a fluorocarbon-type leveling agent.

According to some embodiments of the projection writing and erasing curable coating of the present disclosure, the leveling agent includes at least one of BYK358, BYK354, BYK361, TEGO300, or MODAFLOW9200.

According to some embodiments of the projection writing and erasing curable coating of the present disclosure, when the components of the projection writing and erasing curable coating further includes a diluent, the mass parts of the diluent are 0 to 15 parts. In this way, by adding diluent, construction can be facilitated.

According to some embodiments of the projection writing and erasing curable coating of the present disclosure, the diluent includes at least one of isopropanol, propanol, n-butanol, ethyl acetate, butyl acetate, acetone, butanone, methyl isobutyl ketone, cyclohexanone, toluene, xylene, diacetone alcohol, ethylene glycol ethyl ether, or propylene glycol monomethyl ether.

According to some embodiments of the projection writing and erasing curable coating of the present disclosure, the preparation method of the projection writing and erasing curable coating includes the following steps: the preparation components are mixed and filtered to obtain the projection writing and erasing curable coating.

According to some embodiments of the projection writing and erasing curable coating preparation method of the present disclosure, when the antibacterial agent is an organosilicon quaternary ammonium salt-type antibacterial agent, the specific preparation method is as follows: adding the antibacterial agent, the leveling agent (or no leveling agent), and the writing and erasing aid to the acrylate monomers to disperse, then adding the acrylate prepolymer to disperse, then adding the photoinitiator to continue dispersing, and filter to obtain the projection writing and erasing curable coating.

According to some embodiments of the preparation method of the projection writing and erasing curable coating of the present disclosure, when the antibacterial agent contains nano-inorganic particle-loaded silver ion antibacterial agents, and nano-inorganic particle-loaded zinc ion antibacterial agents, the specific preparation method is as follows: adding the antibacterial agent and the writing and erasing aid to the acrylate monomers to disperse, grinding, then adding the acrylate prepolymer and the leveling agent (or no leveling agent) to disperse, then adding the photoinitiator to continue dispersing, filtering to obtain the projection writing and erasing curable coating. In some embodiments of the disclosure, grinding is performed to a particle size of less than 0.5 microns; and the specific grinding method is conducted by a horizontal sand mill with a grinding medium of 0.3 mm zirconium balls.

According to some embodiments of the preparation method of the projection writing and erasing curable coating of the present disclosure, the photoinitiator is added and the dispersion is continued until the photoinitiator is completely dissolved.

According to some embodiments of the preparation method of the projection writing and erasing curable coating of the present disclosure, the filtration is conducted by a filtration device that exceeds 1 micron. In some embodiments of the present disclosure, the filtration is conducted by a bag filter with a filtration accuracy of 1 micron.

According to some embodiments of the projection writing and erasing film of the present disclosure, the soft film with a roughened surface includes a PP (polypropylene) film, a PE (polyethylene) film, a PET (polyethylene terephthalate) film and a PVC (polyvinyl chloride) film.

According to some embodiments of the projection writing and erasing film of the present disclosure, the film base material layer includes the PET film, PETG (poly(ethylene terephthalateco-1,4-cylclohexylenedimethylene terephthalate)) film, a GAG (a three-layer composite material formed by a middle layer of PET and upper and lower layers of PETG) film, the PP film, the PVC film, the PE film, a PS (polystyrene) film, a PMMA (polymethyl methacrylate) film, a PC (polymer carbonate) film, a PU (polyurethane) film, a TPU (thermoplastic polyurethane) film, a TPE (thermoplastic elastomer) film, and a PA (polyamide) film.

According to some embodiments of the projection writing and erasing film of the present disclosure, the thickness of the film base material layer is 0.01 mm to1.0 mm.

According to some embodiments of the projection writing and erasing film of the present disclosure, the thickness of the film base material layer is 0.05 mm to 0.5 mm.

A second aspect of the present disclosure provides a method for preparing a projection writing and erasing film according to the first aspect of the present disclosure, including the following steps:
step 1): applying the projection writing and erasing curable coating on one surface of the film base material, then compounding it with the soft film with a roughened surface structure, then curing and shaping, and then separating from the soft film to obtain a film base material with a roughened surface structure; and
step 2): compositing with a ferromagnetic layer or an adhesive layer on another surface of the film base material with a surface roughened structure to obtain a projection writing and erasing film having the components described in the first aspect of the present disclosure.

According to the preparation method of the projection writing and erasing film of the present disclosure, the film base material produced through step 1) has a surface structured layer and a film base material layer formed in a stacked mode; and through step 2), an installation layer is formed on another surface of the film base material layer.

According to some embodiments of the projection writing and erasing film preparation method of the present disclosure, the curing and shaping method is ultraviolet light curing or electron beam curing.

According to some embodiments of the preparation method of the projection writing and erasing film of the present disclosure, in step 1), the coating method includes wire bar coating, blade coating, dip coating, roller coating, shower coating, spray coating, gravure coating or dimple coating.

According to some embodiments of the preparation method of the projection writing and erasing film of the present disclosure, in step 2), the composite ferromagnetic layer is coated with magnetic iron powder slurry or bonded with a ferromagnetic film.

According to some embodiments of the preparation method of the projection writing and erasing film of the present disclosure, in step 2), the composite adhesive layer is coated with an adhesive material and then bonded to the surface of the white metal plate. In some embodiments, the adhesive material is pressure-sensitive adhesive or hot melt adhesive.

The third aspect of the present disclosure provides the application of the projection writing and erasing film described in the first aspect of the present disclosure in office, teaching or home projection.

The beneficial effects of the present disclosure are as follows:

The disclosure provides a projection writing and erasing film that can not only satisfy the projection effect, take into account writing and erasing functions, but also have multiple functions such as a magnetic adsorption function and an antibacterial function. The surface of the projection writing and erasing multi-functional film has a roughened structure and low gloss, forming a fine and stable matte surface to achieve the purpose of diffuse reflection and good projection effect, and thus the projection writing and erasing multi-functional film can be used for office, teaching, and home theater-style projection, with broad application prospects.

Specifically, compared with the prior art, the present disclosure has the following advantages:
1. The projection writing and erasing film of the present disclosure has a microscopic surface roughness of 100 nm to 1,000 nm, forming good diffuse reflection, which can solve the problem of reflection.
2. When the installation layer of the projection writing and erasing film is a ferromagnetic layer, it can be magnetically adsorbed and can be used as a display function wall. When the installation layer is an adhesive layer, it can be mounted on the surface of the board/film, broadening the product application and having a wide range of applications.
3. The present disclosure uses varnish to produce a matte surface effect on the projection writing and erasing film, resulting in a more uniform and stable surface without the wiping problem caused by the penetration of water-based ink.
4. The projection writing and erasing curable coating used in the present disclosure does not contain matting powder, and there is no problem of matting powder precipitation or dispersion, which can solve the problem of unstable glossiness when making matte in the prior art.
5. The projection writing and erasing curable coating used in the present disclosure does not contain solvents or has very little solvent content, which can reduce VOC emissions and is more environmentally friendly.
6. The present disclosure uses a UV/electron beam curing and shaping process to produce the projection writing and erasing film, which transfers the roughened surface structure of the soft film to the cured coating surface of the film base material to achieve a matte effect and can reach a low gloss of below 10° or even completely matte effect.

### BRIEF DESCRIPTION OF DRAWINGS

FIG. 1 is a schematic structural diagram of a projection writing and erasing film according to an embodiment of the present disclosure; and

FIG. 2 is a schematic flow chart of preparing a projection writing and erasing film according to an embodiment of the present disclosure.

Reference numerals: 100, surface structured layer; 110, curable coating; 200, film base material layer; 300, installation layer; 400, soft film with roughened surface structure.

### DETAILED DESCRIPTION

The content of the present disclosure will be further described in detail below through specific examples. Unless otherwise specified, the raw materials, reagents or devices used in the examples and comparative examples can be obtained from conventional commercial sources, or can be obtained through existing technical methods. Unless otherwise stated, assays or test methods are routine in the art.

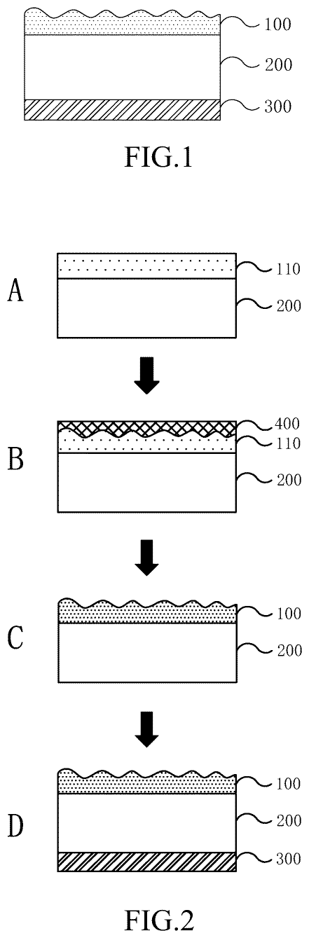

One aspect of the present disclosure provides a projection writing and erasing film. FIG. 1 is a schematic structural diagram of the projection writing and erasing film according to an embodiment. The projection writing and erasing film according to the embodiment of the present disclosure will be described below with reference to FIG. 1.

As shown in FIG. 1, the projection writing and erasing film according to the embodiment of the present disclosure includes a surface structured layer 100, a film base material layer 200 and an installation layer 300 that are stacked in sequence. Among them, the surface structured layer 100 is a matte coating with a roughened surface structure, and the installation layer 300 is a ferromagnetic layer or an adhesive layer.

Another aspect of the present disclosure provides a method for preparing a projection writing and erasing film according to the above embodiment. FIG. 2 is a schematic flow chart for preparing a projection writing and erasing film according to the embodiment. The method for preparing a projection writing and erasing film according to the embodiment of the present disclosure will be described below with reference to FIG. 2.

As shown in FIG. 2, the projection writing and erasing curable coating was first applied to one surface of the film base material, and a curable coating 110 was formed on one surface of the film base material layer 200 (see step A in FIG. 2); the soft film 400 with a roughened surface structure was compounded with the surface of the curable coating 110, and the roughened surface structure of the soft film was transferred to the surface of the curable coating 110 of the film base material (see step B in FIG. 2) for curing and shaping, and then separated from the soft film to obtain a film base material with a roughened surface structure. At this time, a matte coating with a roughened surface structure was formed on one surface of the film base material layer 200, that is, a surface structured layer 100 (see step C in FIG. 2); a ferromagnetic layer or an adhesive layer was compounded on another surface of the film base material with a surface roughened structure to form the installation layer 300, and the finished projection writing and erasing film of the embodiment was produced (see step D in FIG. 2). Among them, the preparation method of the projection writing and erasing curable coating can refer to the content described in CN112876980A.

Referring to FIG. 1 and FIG. 2, further description will be given below with reference to embodiments of the projection writing and erasing film. The dosage “parts” in the following examples refer to “parts by mass” unless otherwise specified.

### Example 1

The raw material ratio of the projection writing and erasing curable coating used in this projection writing and erasing multifunctional film was as follows:

| | | |
|---|---|---|
| U400 (Bayer) | 15 | parts; |
| B175X (Bayer) | 12 | parts; |
| DPHA | 25 | parts; |
| PETA | 12 | parts; |
| HDDA | 6 | parts; |
| 184 | 2.5 | parts; |
| TPO | 0.5 | parts; |
| writing and erasing aid | 3 | parts; |
| BYK358 | 0.3 | parts; and |
| nano-inorganic particle-loaded silver ion | 4 | parts. |

antibacterial agent

The method for preparing the writing and erasing aid in this example was as follows: in a four-neck round-bottomed flask equipped with a mechanical stirrer, a reflux condenser tube, a constant pressure dropping funnel and a nitrogen inlet tube, vacuum and nitrogen filling were repeated three times and then 10.8 parts of low hydrogened silicone oil (hydrogen content 1.1%), 5 parts of γ-methacryloyloxypropyltriethoxysiloxane, 2 parts of hexafluorobutyl methacrylate, 0.8 parts of dodecafluoroheptyl acrylate monomer, 0.4 parts of polymerization inhibitor were added in sequence. The obtained mixture was heated to 100° C. under nitrogen protection, and a catalyst solution containing 400×10⁻⁶ parts of chloroplatinic acid (chloroplatinic acid isopropanol solution) was added dropwise for 2 hours during the heating process. After the dropwise addition, the incubation reaction was continued for 5 hours. After the incubation reaction was completed, the temperature was adjusted to 90° C. and a mixture of 38 parts of tripropylene glycol diacrylate monomers and chloroplatinic acid isopropanol solution (containing 800×10⁻⁶ parts of chloroplatinic acid) was added dropwise for 1.5 hours. After the dropwise addition was completed, the incubation reaction was continued for 4 hours, and samples were then taken for infrared testing. The absorption peak at 2,167 cm⁻¹ (Si—H bond stretching vibration) in the infrared spectrum of the product disappeared, and heating was stopped. After cooling to room temperature, the solvent in the product was removed to obtain a colorless and transparent liquid, and the writing and erasing aid was obtained.

The method for preparing the projection writing and erasing curable coating in this example was as follows: 4 parts of the nano-inorganic particle-loaded silver ion antibacterial agent and 3 parts of the writing and erasing aid were added to the mixture of 12 parts of PETA and 6 parts of HDDA for pre-dispersing at high speed, and then a horizontal sand mill (the grinding medium was 0.3 mm zirconium ball) was used for cyclic grinding until the particle size was less than 0.5 μm to discharge the material, then 25 parts of DPHA, 15 parts of U400, 12 parts of B175X, and 0.3 parts of BYK358 were added for uniform dispersion at high speed, and 2.5 parts of photoinitiator 184 and 0.5 parts of photoinitiator TPO were added and continued to disperse until light all the photoinitiators were dissolved. After filtering by a bag filter with a filtration accuracy of 1 μm, the projection writing and erasing curable coating 1 # was obtained.

The preparation method of the multifunctional film in this example was as follows: the projection writing and erasing curable coating 1 # was applied onto a 125 μm white PET film using a 120-line micro-concave roller. The coating had a dry film thickness of 6 μm, and was compounded with the roughened surface structure of the PP soft film with a gloss of about 20°. After UV light or electron beam curing, a film base material with a roughened surface structure was obtained, with a gloss of 19.5° to 20.5°. The non-rough structured surface of the film was mounted on the ferromagnetic film material using a two-component polyurethane composite adhesive to obtain the multifunctional film in this example (denoted as film 1).

### Example 2

The projection writing and erasing curable coating used in this example was the same as that in Example 1.

The method for preparing the multifunctional film in this example was as follows: the projection writing and erasing curable coating 1 # was applied onto a 75 μm white PET film using a 120-line micro-concave roller. The coating had a dry film thickness of 6 μm, and was compounded with the roughened surface structure of the PET soft film with a gloss of about 5°. After UV light or electron beam curing, a projection writing and erasing functional film was obtained, and a film base material with a roughened surface structure was obtained, with a gloss of 5.5° to 6.5°. The magnetic iron powder slurry was applied onto the non-rough structured surface of the film to obtain the multifunctional film of this example (denoted as film 2).

### Example 3

The projection writing and erasing curable coating used in this example was the same as that in Example 1.

The method for preparing the multifunctional film in this example was as follows: the projection writing and erasing curable coating 1 # was applied onto a 125 μm transparent PET film using a 150-line micro-concave roller. The coating had a dry film thickness of 5 μm, and was compounded with the roughened surface structure of the PP soft film with a gloss of about 20°. After UV light or electron beam curing, a projection writing and erasing functional film was obtained, and a film base material with a roughened surface structure was obtained, with a gloss of 20° to 21°. The unstructured surface of the film was coated with a pressure sensitive adhesive or a hot melt adhesive, and then mounted on the surface of the white metal plate, with a white reflectivity of not less than 50%, to obtain the multifunctional film of this example (denoted as film 3).

### Comparative Example 1

The curable coating used in this comparative example was made by adding matting powder (silica SiO₂) accounting for 8% of the total mass of the projection writing and erasing curable coating based on the raw material formula of the projection writing and erasing curable coating in Example 1, and the average particle size of the matting powder was 5 μm. In the preparation of the projection writing and erasing curable coating, the matting powder was added for mixing and dispersion, to finally filter with a filter accuracy of 10 μm bag filter, and the curable coating 2 # was obtained.

The method for preparing the multifunctional film in this comparative example was as follows: the projection writing and erasing curable coating 2 # was applied onto a 125 μm white PET film using a 120-line micro-concave roller. The coating had a dry film thickness of 6 μm, and was compounded with the roughened surface structure of the PET soft film with a gloss of about 20°. After UV light or electron beam curing, a film base material with a roughened surface structure was obtained, with a gloss of 18° to 19°. The unstructured surface of the film was mounted on a ferromagnetic film material using an acrylic hot melt adhesive to obtain the multifunctional film of this comparative example (denoted as film 4).

### Comparative Example 2

The curable coating used in this comparative example was made by appropriately increasing the amount of the photoinitiator based on the raw material formula of the projection writing and erasing curable coating in Example 1. The rest of the preparation methods was the same as those in Example 1, and the curable coating 3 # was finally obtained.

The raw material ratio of the curable coating 3 # was as follows:

| | | |
|---|---|---|
| U400 (Bayer) | 15 | parts; |
| B175X (Bayer) | 12 | parts; |
| DPHA | 25 | parts; |
| PETA | 12 | parts; |
| HDDA | 6 | parts; |
| 184 | 4.5 | parts; |
| TPO | 1.0 | parts; |
| writing and erasing aid | 3 | parts; |
| BYK358 | 0.3 | parts; and |
| nano-inorganic particle-loaded silver ion | 4 | parts. |
| antibacterial agent | | |

The multifunctional film in this comparative example was made by non-film pressing process and micro-concave direct coating method. Due to the presence of oxygen inhibition, the photoinitiator dose should be appropriately increased to avoid affecting the degree of curing. The specific preparation method was as follows: the curable coating 3 # was applied onto a 75 μm white PET film using a 150-line micro-concave roller. The coating had a dry film thickness of 5 μm. After UV light or electron beam curing, a film base material with a roughened surface structure was obtained, with a gloss of above 95°. The magnetic iron powder slurry was applied onto the unstructured surface of the film to obtain the multifunctional film of this comparative example (denoted as film 5).

### Comparative Example 3

The curable coating used in this comparative example was made by appropriately increasing the amount of the photoinitiator based on the curable coating 2 # in Comparative Example 1. Specifically, the amount of the photoinitiator 184 was adjusted to 4.5 parts, the amount of TPO was adjusted to 1.0 parts, the rest of the raw materials and preparation method were the same as those in Comparative Example 1, and the curable coating 4 # was finally obtained.

The multifunctional film in this comparative example was also made using a non-film pressing process. The specific preparation method was as follows: after adjusting the solid content of the curable coating 4 # to 100%, the coating was applied onto a 75 μm PET film using a 120-line micro-concave roller. The coating had a dry film thickness of 7 μm. After UV curing, the film base material was obtained with a gloss of 50° to 70°. The obtained film base material was mounted to the ferromagnetic film material by the acrylic hot melt adhesive to obtain the multifunctional film in this comparative example (denoted as film 6).

### Comparative Example 4

The curable coating used in this comparative example was made by adding matting powder (silica SiO₂) accounting for 3% of the total mass of the projection writing and erasing curable coating and appropriately increasing the photoinitiator dose based on the raw material formula of the projection writing and erasing curable coating in Example 1, and the average particle size of the matting powder was 5 μm. In the preparation of the projection writing and erasing curable coating, the matting powder was added for mixing and dispersion, to finally filter with a filter accuracy of 1 μm bag filter, and the curable coating 5 # was obtained.

The raw material ratio of the curable coating 5 # was as follows:

| | | |
|---|---|---|
| U400 (Bayer) | 15 | parts; |
| B175X (Bayer) | 12 | parts; |
| DPHA | 25 | parts; |
| PETA | 12 | parts; |
| HDDA | 6 | parts; |
| SiO2 | 2.5 | parts; |
| 184 | 5 | parts; |
| TPO | 1.0 | parts; |
| writing and erasing aid | 3 | parts; |
| BYK358 | 0.3 | parts; and |
| nano-inorganic particle-loaded silver ion | 4 | parts. |
| antibacterial agent | | |

The multifunctional film in this comparative example was also made using a non-film pressing process. The specific preparation method was as follows: the curable coating 5 # was diluted with toluene in a ratio of 1:1. After the solid content was 50%, the coating was applied onto a 75 μm PET film using a 120-line micro-concave roller. The coating had a dry film thickness of 5 μm. After curing with a high-pressure mercury lamp, the film base material was obtained with a gloss of 18° to 22°. The obtained film base material was mounted to the ferromagnetic film material by the acrylic hot melt adhesive to obtain the multifunctional film in this comparative example (denoted as film 7).

The films 1 to 7 prepared in Examples 1 to 3 and Comparative Examples 1 to 4 were respectively tested for gloss, coating adhesion, coating pencil hardness, writing adhesion, coating wear resistance, erasability, and antibacterial effect. The test results were shown in Table 1. The test method was described as follows:
1. Gloss: measured using a 60° angle glossmeter with model MG-60 provided by Shanghai Lichen Bangxi Instrument Technology Co., Ltd.
2. Coating adhesion: refer to the national standard “GB/T 9286-1998 Cross-cut test of paint and varnish films”.
3. Coated pencil hardness: refer to the national standard “GB/T 6739-2006 Paints and varnishes-Determination of film hardness by pencil tests”.
4. Writing adhesion: refer to the industry standard “QB/T 4153-2010 Whiteboard writing”. “V” means smooth handwriting, uniform handwriting, and obvious lines without breaks; “A” means slight shrinkage at the edge of the handwriting, and still obvious lines without breaks; and “x” means that significantly shrunk handwriting with obvious broken lines and even shrunk into ink dots.
5. Coating wear resistance: refer to the industry standard “QB/T 4153-2010 Whiteboard writing”. “V” means that the writing and wiping functions of the writing surface are normal after the test; and “x” means that there are scratches, ink residue and other defects on the writing surface after the test.
6. Erasability: refer to the industry standard “QB/T 4153-2010 Whiteboard writing”, where the test was carried out by method A shown in standard 5.3.2.2. “V” means no handwriting remains on the writing surface after the test; and “x” means handwriting remains on the writing surface after the test.
7. Antibacterial effect: the test was carried out with reference to the national standard “GB/T 31402-2015 Plastics-Measurement of antibacterial activity on plastics surfaces”, and the tested strain was Escherichia coli. When the antibacterial activity value is ≥2, and the antibacterial efficacy is ≥99%, it is considered to have an antibacterial effect.

TABLE 1
Performance test results of films 1 to 7

| | | | | | | | | antibacterial effect | |
|---|---|---|---|---|---|---|---|---|---|
| | | | | | | | | antibac- | antibac- |
| | | | | coating | | coating | | terial | terial |
| film | | | coating | pencil | writing | wear | eras- | activity | efficacy |
| number | Gloss (°) | | adhesion | hardness | adhesion | resistance | ability | value | (%) |
| 1 | 19.5-20.5 | | 0 | H | √ | √ | √ | 2.92 | 99.88 |
| 2 | 5.5-6.5 | | 0 | H | √ | √ | √ | 2.92 | 99.88 |
| 3 | 20-21 | | 0 | H | √ | √ | √ | 2.92 | 99.88 |
| 4 | 18-19 | | 0 | H-2H | √ | √ | √ | 2.42 | 99.58 |
| 5 | 95-100 | | 0 | H | √ | √ | √ | 2.65 | 99.66 |
| 6 | horizontal | 50-60 | 0 | H-2H | √ | √ | √ | 2.40 | 99.52 |
| | longitudinal | 60-70 | | | | | | | |
| 7 | horizontal | 18-20 | 0 | H | √ | √ | X | 2.00 | 99.02 |
| | longitudinal | 20-22 | | | | | | | |

Films 1 to 7 were tested for surface roughness, erasability, projection, bright spots or light spots. The test results were shown in Table 2. The test method was described as follows:
1. Surface roughness: testing was performed by TR110A surface roughness meter produced by Beijing Times Shuncheng Technology Co., Ltd.; where Ra: contour arithmetic mean deviation; Rz: ten-point height of microscopic roughness; Rq: contour root mean square deviation; Rt: total height of contour peaks and valleys.
2. Erasability: refer to the industry standard “QB/T 4153-2010 Whiteboard writing”, where the test was carried out by method A shown in standard 5.3.2.2. “V” means no handwriting remains on the writing surface after the test; and “x” means handwriting remains on the writing surface after the test.
3. Projection: tested by Epson projector CB-E01 and Panasonic projector PT-SX4000.
4. Bright spots or light spots: visually inspected 2-3 meters away from the multifunctional film under projection.

TABLE 2
Performance test results of films 1 to 7

| film | | | surface roughness (μm) | | | | eras- | | |
|---|---|---|---|---|---|---|---|---|---|
| number | Gloss (°) | | Ra | Rz | Rq | Rt | ability | project | spots |
| 1 | 19.5-20.5 | | 0.25-0.45 | 1.50-2.50 | 0.30-0.50 | 2.10-2.60 | √ | ⊚ | no |
| 2 | 5.5-6.5 | | 0.45-0.70 | 2.10-3.50 | 0.50-0.80 | 2.80-3.80 | √ | ⊚ | no |
| 3 | 20-21 | | 0.20-0.40 | 1.30-2.20 | 0.25-0.45 | 2.00-2.50 | √ | ⊚ | no |
| 4 | 18-19 | | 0.30-0.50 | 1.80-2.50 | 0.35-0.55 | 2.20-2.80 | √ | ⊚ | no |
| 5 | 95-100 | | 0.02-0.10 | 0.10-0.50 | 0.01-0.10 | 0.15-0.50 | √ | X | large |
| | | | | | | | | | light spot |
| 6 | horizontal | 50-60 | 0.15-0.30 | 0.90-2.05 | 0.15-0.50 | 0.90-3.30 | √ | X | large |
| | longitudinal | 60-70 | 0.15-0.30 | 1.0-1.95 | 0.20-0.40 | 1.50-2.80 | | | light spot |
| 7 | horizontal | 18-20 | 0.30-0.50 | 2.0-3.0 | 0.30-0.60 | 2.20-4.50 | X | ⊚ | no |
| | longitudinal | 20-22 | 0.25-0.45 | 1.90-2.5 | 0.35-0.55 | 2.30-3.50 | | | |

According to the test results in Table 1 and Table 2, the projection writing and erasing multifunctional films 1-3 obtained in Examples 1-3 were relatively excellent in coating adhesion, hardness, writing adhesion and erasability, and have significant antibacterial effects. 8% matting powder was added in Comparative Example 1 (Film 4) with 100% solid content to form a coating which was also made by the film pressing process, with a gloss basically equivalent to the film gloss. However, there were the following defects caused by the addition of the matting powder: 1. when the coating was thin, the matting powder could not be completely hidden in the coating, and the gloss would be unstable; 2. prolonged processing time and accumulation of the matting powder due to precipitation, would lead to unstable gloss; and 3. the matting powder would increase the cost of raw materials, make the coating process more troublesome, and also extend the production time. Comparative Example 2 (Film 5) was provided with 100% solid content without matting powder, and involved a direct coating process. The film had a gloss of above 90°, resulting in no projection. 8% matting powder was added in Comparative Example 3 (Film 6) with 100% solid content, and adopted a direct coating process. The matting powder adsorbed monomers, causing the resin to increase the viscosity and was wrapped during curing, which could not achieve an ideal matting effect, and the gloss was unstable with horizontal and vertical differences. However, since the film of the example was made by a molding process, there is no difference in horizontal and vertical gloss. 3% matting powder was added in Comparative Example 4 (Film 7) with 50% solid content, and involved a direct coating process. By using a solvent and low viscosity, the matting powder migrated to the surface while the solvent evaporated, resulting in good matting, however, the matting powder had a porous structure, and the writing ink would penetrate into its pores, making it impossible to wipe off and leaving an afterimage.

In the embodiments of the present disclosure, a projection writing and erasing curable coating was applied to the surface of the film, and was compounded with a soft film with a roughened surface structure, and the roughened structure of the soft film surface was transferred to the surface of the film through the UV/EB curing process, which could reduce the gloss, achieved a fine matte surface and diffuse reflection, had a good projection effect, and solved the problems of light spots and bright spots that existed in the prior art. The projection writing and erasing multifunctional film provided by the embodiments of the present disclosure could have both projection effect and writing and erasing function, as well as magnetic adsorption function, antibacterial and other functions. This projection writing and erasing multi-functional film could be used for office, teaching, and home theater-style projection, and had a broad application prospect.

The above embodiments are preferred embodiments of the present disclosure, but the embodiments of the present disclosure are not limited to the above embodiments. Any other changes, modifications, substitutions, combinations, and simplifications made without departing from the spirit and principles of the present disclosure should be equivalent replacement methods and are all included in the protection scope of the present disclosure.

1. A projection writing and erasing film, comprising a surface structured layer, a film base material layer and an installation layer which are arranged in a stacked mode;
wherein the surface structured layer is a matte coating with a roughened surface structure; and
wherein the installation layer is a ferromagnetic layer or an adhesive layer.

2. The projection writing and erasing film according to claim 1, wherein the surface structured layer has a surface gloss of ≤30°.

3. The projection writing and erasing film according to claim 1, wherein the surface structured layer is formed by compounding a projection writing and erasing curable coating and a soft film with a roughened surface structure, curing and shaping, and then separating the projection writing and erasing curable coating from the soft film.

4. The projection writing and erasing film according to claim 3, wherein the projection writing and erasing curable coating comprises the following preparation components: a base material, a photoinitiator, an antibacterial agent, and a writing and erasing aid; and wherein the base material comprises acrylate resin prepolymers and acrylate-type monomers, and the writing and erasing aid is a fluorosilicone co-modified polyacrylate resin.

5. The projection writing and erasing film according to claim 4, wherein the projection writing and erasing curable coating comprises the following preparation components in parts by mass: 25 to 55 parts of the acrylate resin prepolymers, 12 to 48 parts of the acrylate-type monomers, 1.0 to 4.0 parts of the photoinitiator, 1 to 8 parts of the antibacterial agent, and 1 to 5 parts of the writing and erasing aid; and wherein the writing and erasing aid comprises the following preparation components in parts by mass: 8 to 12 parts of hydrogen silicone oil, 3 to 8 parts of silane monomers, 20 to 55 parts of bifunctional (meth)acrylate monomers, 1 to 3 parts of fluorine-containing (meth)acrylate monomers, 7×10⁻⁴ to 1.5×10⁻³ parts of catalyst, and 0.3 to 0.6 parts of polymerization inhibitor.

6. The projection writing and erasing film according to claim 3, wherein the soft film with a roughened surface structure comprises at least one of a polypropylene film, a polyethylene film, a polyethylene terephthalate film or a polyvinyl chloride film.

7. The projection writing and erasing film according to claim 1, wherein the film base material layer comprises at least one of a polyethylene terephthalate film, a poly(ethylene terephthalateco-1,4-cyclohexylenedimethylene terephthalate) film, a three-layer composite material formed by a middle layer of amorphous polyethylene terephthalate and upper and lower layers of poly(ethylene terephthalateco-1,4-cylclohexylenedimethylene terephthalate) film, a polypropylene film, a polyvinyl chloride film, a polyethylene film, a polystyrene film, a polymethyl methacrylate film, a polycarbonate film, a polyurethane film, a thermoplastic polyurethane film, a thermoplastic elastomer film or a polyamide film.

8. A preparation method of a projection writing and erasing film, comprising the following steps:
1) applying a projection writing and erasing curable coating on one surface of a film base material, then compounding the projection writing and erasing curable coating with a soft film with a roughened surface structure, curing and shaping, and then separating the projection writing and erasing curable coating from the soft film to obtain the film base material with a roughened surface structure; and
2) compounding with a ferromagnetic layer or an adhesive layer on another surface of the film base material with a surface roughened structure to obtain the projection writing and erasing film as claimed in claim 1.

9. The preparation method according to claim 8, wherein the curing and shaping is ultraviolet curing or electron beam curing.

10. The preparation method according to claim 8, wherein the surface structured layer has a surface gloss of ≤30°.

11. The preparation method according to claim 8, wherein the surface structured layer has a Ra of 0.10 μm to 1.0 μm.

12. The preparation method according to claim 8, wherein the surface structured layer has a Rt of 1.0 μm to 5.0 μm.

13. The preparation method according to claim 8, wherein the surface structured layer has a thickness of 1 μm to 20 μm.

14. The preparation method according to claim 8, wherein the surface structured layer is formed by compounding the projection writing and erasing curable coating and the soft film with a roughened surface structure, curing and shaping, and then separating the projection writing and erasing curable coating from the soft film.

15. The preparation method according to claim 14, wherein the projection writing and erasing curable coating comprises the following preparation components: a base material, a photoinitiator, an antibacterial agent, and a writing and erasing aid; and wherein the base material comprises acrylate resin prepolymers and acrylate-type monomers, and the writing and erasing aid is a fluorosilicone co-modified polyacrylate resin.

16. The preparation method according to claim 15, wherein the projection writing and erasing curable coating comprises the following preparation components in parts by mass: 25 to 55 parts of acrylate resin prepolymers, 12 to 48 parts of acrylate-type monomers, 1.0 to 4.0 parts of photoinitiator, 1 to 8 parts of antibacterial agent, and 1 to 5 parts of the writing and erasing aid; and wherein the writing and erasing aid includes the following preparation components in parts by mass: 8 to 12 parts of hydrogen silicone oil, 3 to 8 parts of silane monomers, 20 to 55 parts of bifunctional (meth)acrylate monomers, 1 to 3 parts of fluorine-containing (meth) acrylate monomers, 7×10⁻⁴ to 1.5×10⁻³ parts of catalyst, and 0.3 to 0.6 parts of polymerization inhibitor.

17. The preparation method according to claim 14, wherein the soft film with a roughened surface structure comprises at least one of a polypropylene PP film, a polyethylene PE film, a polyethylene terephthalate PET film or a polyvinyl chloride PVC film.

18. The projection writing and erasing film according to claim 1, wherein the surface structured layer has a Ra of 0.10 μm to 1.0 μm.

19. The projection writing and erasing film according to claim 1, wherein the surface structured layer has a Rt of 1.0 μm to 5.0 μm.

20. The projection writing and erasing film according to claim 1, wherein the surface structured layer has the thickness of 1 μm to 20 μm.
